(19) United States
(12) Patent Application Publication
(10) Pub. No.: US 2007/0030605 A1
(43) Pub. Date: Feb. 8, 2007

(54) Voice recorder apparatus

(75) Inventor: Christina L. Treu, Lehi, UT (US)

Correspondence Address: STOEL RIVES LLP - SLC, 201 SOUTH MAIN STREET, ONE UTAH CENTER, SALT LAKE CITY, UT, 84111, US

(73) Assignee: Treu An' Current, LLC, Lehi, UT (US)

(21) Appl. No.: 11/487,649

(22) Filed: Jul. 17, 2006

Related U.S. Application Data
(60) Provisional application No. 60/705,411, filed on Aug. 4, 2005.

(51) Int. Cl. G11B 5/012

(52) U.S. Cl. 360/903; 360/97.01

(57) ABSTRACT

A voice recorder for use in book pages, such as in a scrapbook, includes a casing with front and back panels such that a covering, such as paper or fabric, covers at least the front side. A recessed playback button is defined within the front side. A recessed record button is defined within either the front or back sides. Included is an integrated microphone to record audio when the recessed record button is depressed. Non-volatile memory is for storage of the audio. A speaker is included for playing back the recorded audio when the recessed playback button is depressed.

### PRIORITY CLAIM

This application claims priority to U.S. Provisional Patent Application Ser. No. 60/705,411, entitled “Voice Recorder Apparatus,” filed Aug. 04, 2005, which is hereby incorporated by reference.

### TECHNICAL FIELD

The present invention relates generally to a voice player and recorder, and more specifically, to a voice recorder apparatus usable inside of book pages.

### BRIEF DESCRIPTION OF THE DRAWINGS

A more particular description of the disclosure will be rendered by reference to the appended drawings. Understanding that these drawings only provide information concerning typical embodiments of the disclosure and are not therefore to be considered limiting of its scope, the disclosure will be described and explained with additional specificity and detail through use of the accompanying drawings.

FIGS. 1A and 1B show front and back views, respectively, of one embodiment of a voice recorder apparatus.

FIG. 2 shows a voice recorder apparatus with a portion of a covering cut away.

FIG. 3 shows a cross-sectional view of a voice recorder apparatus inside a covering.

FIG. 4 shows a perspective view of an embodiment of a voice recorder apparatus.

FIG. 5 shows a perspective view of the opposite side of the embodiment shown in FIG. 2.

FIG. 6 illustrates views of a voice recorder apparatus with dimensions.

FIG. 7 illustrates perspective views of a voice recorder apparatus.

FIG. 8 is a schematic of one embodiment of a voice recorder.

### DETAILED DESCRIPTION OF PREFERRED EMBODIMENTS

The presently preferred embodiments of the present disclosure will be best understood by reference to the drawings, wherein like parts are designated by like numerals throughout. It will be readily understood that the components of the present disclosure, as generally described and illustrated in the Figures herein, could be arranged and designed in a wide variety of different configurations. Thus, the following more detailed description of the embodiments of the apparatus, system, and method of the present disclosure is not intended to limit the scope of the disclosure, but is merely representative of presently preferred embodiments of the disclosure.

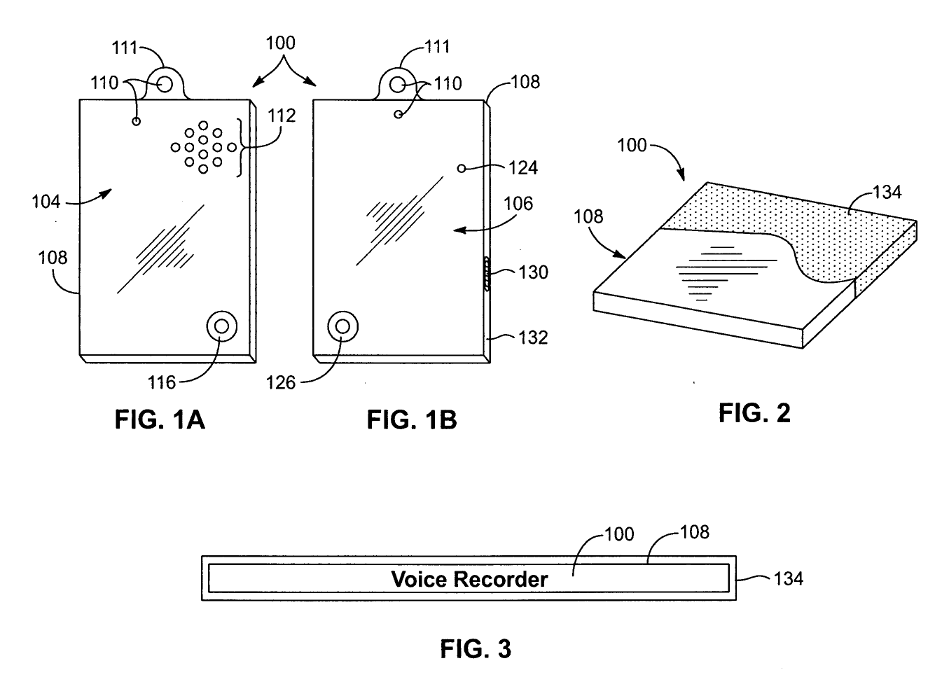

Referring to FIGS. 1A and 1B, displayed are front and rear views of a voice recorder 100 having, respectively, front and rear panel (or sides) 104, 106. The voice recorder 100 includes a casing 108 that may be embodied as a thin, flat rectangle, but may also be implemented as any geometric shape, to include a triangle, a square, a circle, an oval, etc. The casing 108 may be manufactured to be substantially thin, such as less than 6 mm in depth in one embodiment, to accommodate nesting of the voice recorder 100 within a book. The casing 108 may additionally define an aperture 110 through which to tie off a string, yarn, cord, etc. (hereinafter “cord”) (not shown) for hanging the voice recorder between pages of the book. In an alternative embodiment, a ring or bracket 111 having an aperture 110 is attached to the voice recorder 100 for the same purpose.

These are only examples of means of attachment. One of skill in the art will appreciate that the cord may be glued or otherwise adhesively applied directly to the recorder 100, or the cord may be tied about the length or the width of the recorder 100, and the recorder 100 subsequently adhered, or otherwise attached, to the page of a book. Furthermore, a clip (not shown) may be springingly attached to the recorder 100 and then attached to the page of the book. For instance, the clip may have two-sided claws, one for attachment to the recorder 100, and the other for attachment to the page. Of course, the other side may be configured for attachment to the cord, for hanging from the page.

The casing 108 includes a front panel 104 that includes perforations 112. The perforations 112 allow the output from a voice playback speaker (not shown) to be heard. The front panel 104 also includes a recessed playback button 116 to activate play back of a recording stored in the voice recorder 100. The recessed feature of the playback button 116 prevents inadvertent or continuous playback when pressure is applied to the casing 108 of the voice recorder 100, such as when the voice recorder 100 is inserted into a book (not shown) and the book is closed.

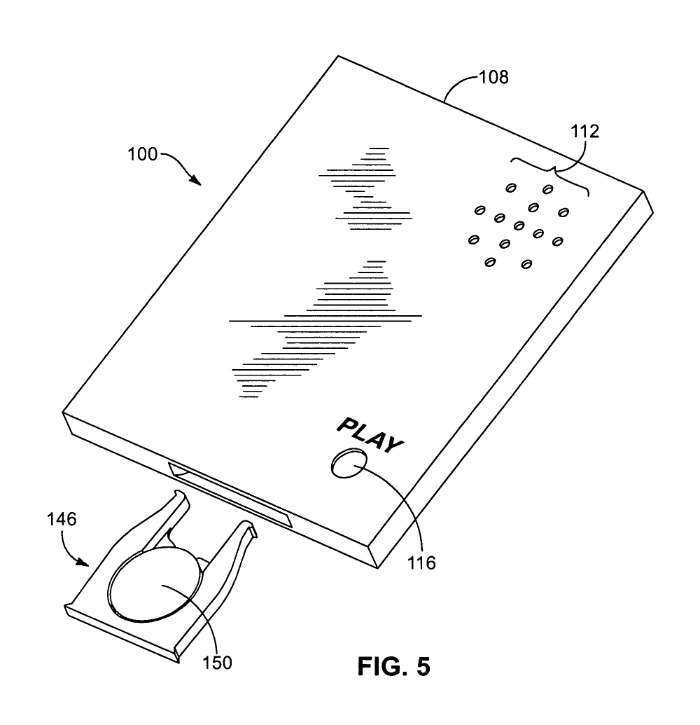

The rear panel 106, shown in FIG. 1B, includes an input location 124 in the casing 108 of the voice recorder 100 for electrical communication with a microphone (not shown). The rear panel 106 includes a record button 126. The record button 126 may be recessed to prevent inadvertent recording and to protect recordings already made. Also, the recessed record button 126 and/or the microphone input location 124 may be variably located on the front panel 104 of the casing 108. When the record button 126 is pressed and a user talks into the microphone at location 124, a recording is stored on a nonvolatile memory (not shown). The non-volatile memory prevents loss of the recording when a battery (150 in FIG. 5) is exhausted and must be changed. Different embodiments may offer varying amounts of recording memory, which may include at least 30 to 60 seconds of record time, or more.

In one embodiment, the voice recorder 100 includes a disable switch 130. The disable switch 130 is to prevent operation of the record button 126 to thereby preserve a recording. The disable switch is located on an edge 132 (or thin side) of the casing 108, as displayed in one embodiment, but may be located anywhere on the casing 108 in various other embodiments. The disable switch 130 may be embodied as either a mechanical device or an electrical device. In an alternative embodiment, the voice recorder 100 may protect a recording stored thereon by requiring that the playback button 116 on the front panel 104 and the record button 126 on the back panel be pressed simultaneously to activate recording.

Referring to FIG. 2, a cutaway view of a voice recorder inside a covering 134 is shown. The covering 134 may include a variety of materials such as paper, fabric, plastic, etc., which may be decorated with a variety of designs. The voice recorder 100 may be partially or completely encapsulated. For example, only the front panel 104 may be covered as it is the most visible to observers, or the entire casing 108 may be covered. The covering 134 may have designations indicating the locations of the record button 126 and/or the playback button 116, among other locations. One embodiment of the voice recorder 100 may allow for paper coverings 134 to be used to decorate a voice recorder 100 as an accessory to a scrapbook page (not shown). As such, the voice recorder 100 may play back sounds that correspond to the photographs on the scrapbook page. If the voice recorder 100 is used in a scrapbook page, the paper coverings may be acid-free. The voice recorder 100 may additionally record multiple recordings that correspond to a plurality of photographs on a page.

The voice recorder 100 may adhere to the page of a scrapbook in a desired location for strategic effect, and to prevent shifting. Adhering of the voice recorder 100 may be through sticky attachment tabs, an acid-free glue, through additional accessories that “frame” the voice recorder 100, through hanging the voice recorder from an attached cord through aperture 110, or other methods of attaching a scrapbook accessory known in the art.

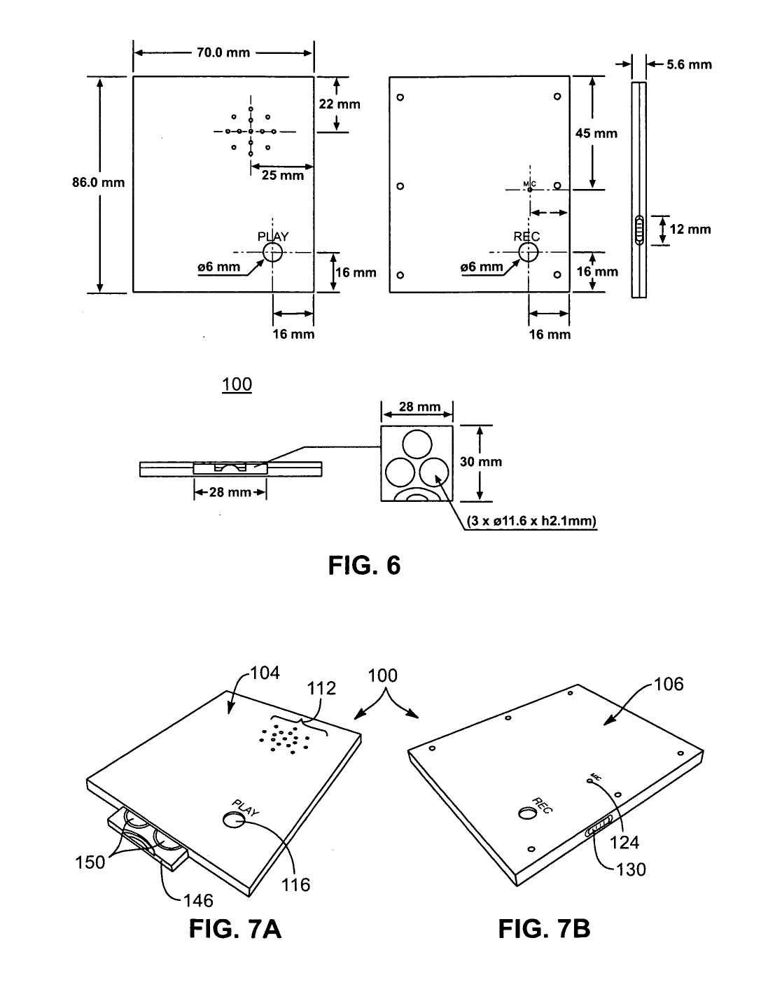

The covering 134 may be plain, stamped, inked, dyed, sanded, painted, covered with stickers or other embellishments, patterned, embossed, colored, or otherwise decorated. The playback of the sound recording(s) is loud enough to be heard through the covering 134 and through an additional thin covering, such as a page protector of the type used in scrapbooks. A speaker amplifier (828 in FIG. 6) may be employed to aid in boosting the sound level.

Referring to FIG. 3, a cross-sectional view of the voice recorder 100 inside a covering 134 is shown. Shown is an embodiment that is compact, and substantially thin. In this embodiment, the covering 134 adheres to the voice recorder 100 apparatus with no gap or spacing between the casing 108 and the covering 134. Adhering may be accomplished with glue, a self-adhesive strip exposed through removal of a strip covering, or through other adhesives known in the art. Another embodiment includes a close-fitting sleeve, wherein the covering 134 does not adhere to the casing, but provides virtually no gap or spacing between the casing 108 and the covering 134.

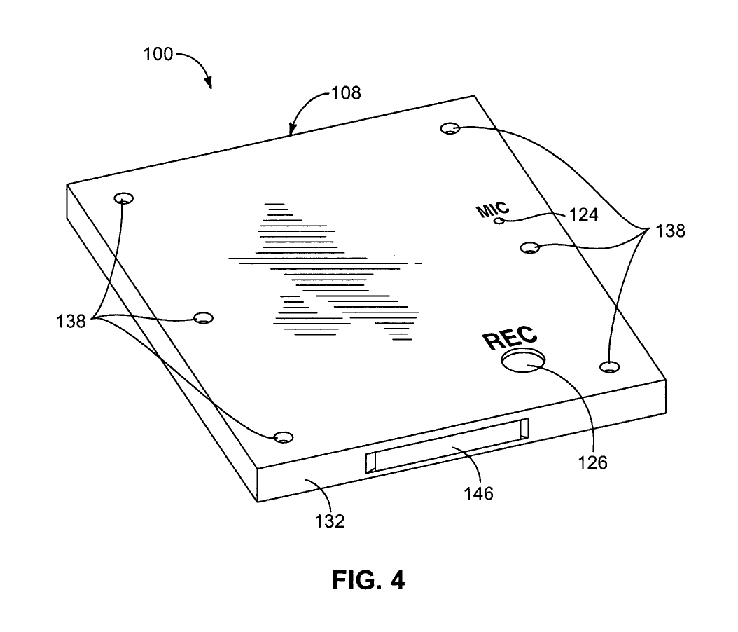

Referring to FIG. 4, a perspective view of the voice recorder 100 is shown. Also shown are the record button 126 and a plurality of recessed fasteners 138 that hold the voice recorder 100 together. The location 124 for an integrated voice recording microphone is also shown. Along the edge 132 of the voice recorder 100, a slidable battery cartridge 146 is shown in a closed position. The battery cartridge 146 houses a battery (150 in FIG. 5) and slides out so that the voice recorder 100 does not have to be removed from a book page to change the battery.

Referring to FIG. 5, a perspective view of a voice recorder 100 is shown displaying the recessed playback button 116 and perforations 112 in the casing 108 for the playback speaker output. FIG. 5 also shows the sliding battery cartridge 146 in an open position, extended out from the casing 108 to enable battery 150 replacement without having to change the position of the voice recorder 100. The voice recorder 100 may be manufactured as an integral, or self-sustaining, unit with the above-listed elements, such as the microphone location 124, the speaker perforations 112, record capability, and an internal power source (or battery 150).

Referring to FIG. 6, plan views and side views are shown of a voice recorder 100. FIG. 6 further illustrates dimensions of an embodiment of a voice recorder 100. As will be appreciated by one of skill in the art, the dimensions may vary, all of which are within the scope of the disclosure. Also shown is another embodiment of the slidable battery cartridge 146, wherein three batteries 150 are located therein. Therefore, the number or shape of the batteries 150 are not limiting of the scope of this disclosure.

Referring to FIGS. 7A and 7B, perspective views are shown of an embodiment of a voice recorder 100, such as of the embodiment shown in FIG. 6. The slidable battery cartridge 146 is partially-opened, displaying two of the batteries 150 therein.

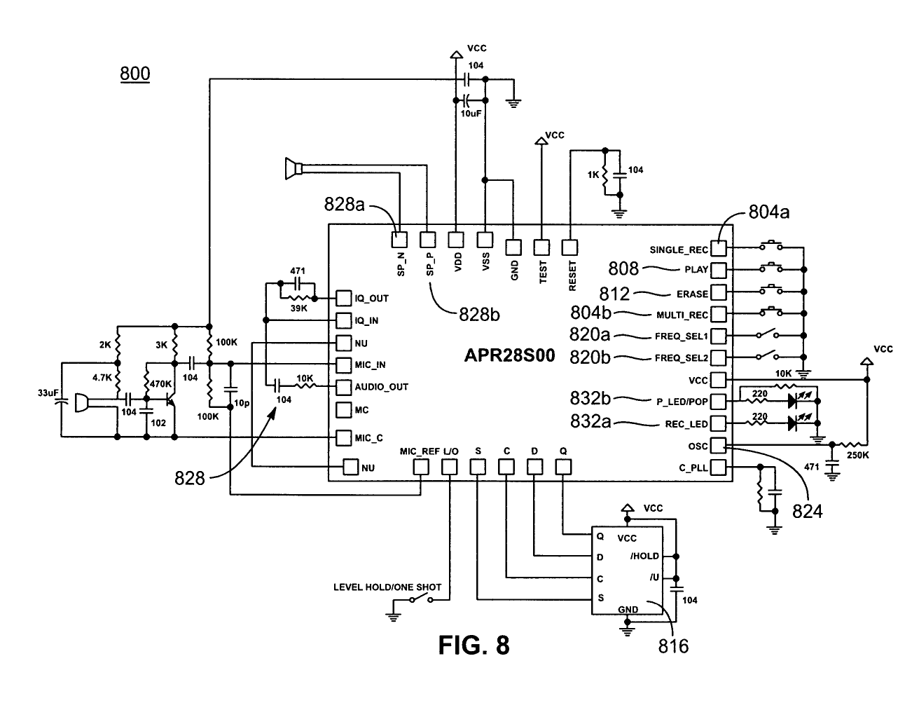

Referring to FIG. 8, a schematic 800 of an embodiment of a voice recorder 100 apparatus is shown. Other various circuit components may be included, as implemented by one of skill in the art, and therefore not every possible component is shown in FIG. 8. The voice recorder 100 provides a push-button user interface (not shown) for various options, as implemented in the schematic 800. For instance, the SINGLE_REC option 804a may connect to the record button 126 positioned within the casing 108 of the voice recorder 100. The same or different record button 126 may connect to the MULTI_REC option 804b to record more than one message for playback. Likewise, the PLAY button 808 may connect to the recessed playback button 116 positioned within the casing 108, as discussed. Also, the ERASE button 812 may connect to a recessed erase button (not shown), or connect via logic to a controller 816 to execute erasing when the record button 804a or 804b is first actuated.

The voice recorder 100 may, therefore, provide both single-message and multi-message record (804a, 804b) and playback (608) options. A user may select a recording rate of 4 kHz, 6 kHz, or 8 kHz, or others, via the FREQ_SEL1 (820a) and/or FREQ_SEL2 (820b) options, which may be selected via the user interface. The voice recorder 100 may include CMOS devices and an on-chip oscillator (shown as OSC 824) with an external control. A speaker amplifier 828 may also be included, or another amplifier as implemented by one of skill in the art. A voice recording may be stored in an on-chip, non-volatile memory cell (not shown) to provide zero-power message storage. Audio signals may be stored directly to the non-volatile memory cell in their natural form to provide high-quality, solid state voice reproduction.

An automatic power-down mode may be provided to enter a standby mode following record, playback, and erase cycles, or otherwise not in use. Enabling such a standby mode of the voice recorder will preserve battery 150 power, thus requiring replacement less often. The voice recorder 100 may also include on-chip speaker drivers 828a, 828b with a built-in amplifier and two LEDs to indicate recording 832a and playback 832b.

While specific embodiments and applications of the present disclosure have been illustrated and described, it is to be understood that the disclosure is not limited to the precise configuration and components disclosed herein. Various modifications, changes, and variations apparent to those of skill in the art may be made in the arrangement, operation, and details of the methods and systems of the present disclosure disclosed herein without departing from the spirit and scope of the present disclosure.

1. A voice recorder comprising:
a casing comprising front and back sides;
a covering adhering to at least the front side;
a recessed playback button defined within the front side;
an integrated microphone to record audio;
non-volatile memory in electrical communication with the integrated microphone for storage of the recorded audio; and
a speaker in electrical communication with the non-volatile memory to play back the recorded audio when the recessed playback button is depressed.

2. The voice recorder of claim 1, further comprising:
a record button defined within one of the front and back sides, wherein depression of the record button enables recording audio through the microphone.

3. The voice recorder of claim 2, wherein to record audio, the voice recorder is configured to require simultaneous depression of the recessed playback and record buttons.

4. The voice recorder of claim 1, wherein the casing comprises at least one edge, the voice recorder further comprising:
a slidable battery cartridge defined within the at least one edge.

5. The voice recorder of claim 1, further comprising:
a disable switch, wherein if activated, prevents recording over the last recorded audio.

6. The voice recorder of claim 1, wherein the covering is paper.

7. The voice recorder of claim 6, wherein the paper is acid-free.

8. The voice recorder of claim 1, wherein the covering is fabric.

9. The voice recorder of claim 1, wherein the cover is decorative.

10. The voice recorder of claim 1, wherein the casing comprises a surface and the covering adheres to substantially the entire surface.

11. The voice recorder of claim 1, wherein the covering comprises a close-fitting sleeve into which the casing is inserted.

12. The voice recorder of claim 1, further comprising:
an amplifier in electrical communication with the speaker, wherein the recorded audio is audible through a protective cover of a scrapbook page.

13. The voice recorder of claim 1, wherein the voice recorder is configured to play back recorded audio multiple times.

14. The voice recorder of claim 1, wherein the recorded audio comprises a plurality of recorded messages.

15. The voice recorder of claim 14, wherein the plurality of recorded messages correspond to a plurality of photographs.

16. The voice recorder of claim 1, wherein the casing comprises an aperture through which a cord is attached to hang the voice recorder within a page of a book.

17. The voice recorder of claim 1, further comprising a cord coupled to the casing to allow the recorder to be hung within a page of a book.

18. The voice recorder of claim 1, further comprising:
a battery; and
an automatic power-down mode to enable the voice recorder to enter a standby state when not in use, to converse the battery's life.

19. A voice recorder comprising:
a casing comprising a plurality of sides;
a recessed playback button defined within a first side;
a recessed record button defined within one of the first side and a second side;
an integrated microphone, wherein a user records at least one message by depressing the recessed record button;
an integrated speaker to play back the recorded message when the recessed playback button is depressed; and
a covering that substantially conforms to the entire casing.

20. The voice recorder of claim 19, further comprising:
a slidable battery cartridge located within an edge of the casing to carry a battery to power the voice recorder.

21. The voice recorder of claim 19, wherein the covering comprises fabric.

22. The voice recorder of claim 19, wherein the covering comprises acid-free paper.

23. The voice recorder of claim 19, wherein the covering is decorative.

24. The voice recorder of claim 19, further comprising:
a speaker amplifier to boost the playback recording sound such that the sound is discernable through the covering and a page protector.

25. The voice recorder of claim 19, further comprising:
a disable switch, wherein if activated, prevents recording over the last recorded message.

26. The voice recorder of claim 19, wherein to record a message, the voice recorder is configured to require simultaneous depression of the recessed playback and record buttons.

27. The voice recorder of claim 19, further comprising:
non-volatile memory to store the at least one message.

28. The voice recorder of claim 27, wherein the non-volatile memory has stored thereon a plurality of messages, each message corresponding to at least one photograph of a scrapbook page.

29. The voice recorder of claim 19, wherein the voice recorder is configured to play back the at least one recorded message multiple times.

30. The voice recorder of claim 19, further comprising means for hanging the recorder within a page of a book.

31. The voice recorder of claim 19, further comprising:
a battery; and
an automatic power-down mode to enable the voice recorder to enter a standby state when not in use, to converse the battery's life.

32. A method of providing a voice recording within the pages of a book, the method comprising:
covering a voice recorder having recessed playback and record buttons with a covering;
pressing the record button to record a message relevant to one or more photographs present on a page of the book; and
disposing the voice recorder on the page having the photographs relevant to the recording.

33. The method of claim 32, further comprising:
covering the page with a protective sheet.

34. The method of claim 32, further comprising:
pressing the playback button to playback a previously recorded message.

35. The method of claim 32, further comprising:
adhering the covering to a surface of the voice recorder.

36. The method of claim 32, further comprising:
attaching a cord to the voice recorder to hang the voice recorder within the pages of the book.

37. The method of claim 32, further comprising:
adhering the covered voice recorder to a page of the book.
